(19) United States
(12) Patent Application Publication
(10) Pub. No.: US 2024/0428960 A1
(43) Pub. Date: Dec. 26, 2024

(54) FUEL-MODERATOR INVERSION FOR SAFER NUCLEAR REACTORS

(71) Applicant: ULTRA SAFE NUCLEAR CORPORATION, Seattle, WA (US)

(72) Inventors: Lorenzo Venneri, Los Alamos, NM (US); Francesco Venneri, Seattle, WA (US); Paolo Francesco Venneri, Seattle, WA (US)

(21) Appl. No.: 18/278,119

(22) PCT Filed: Jun. 3, 2022
(86) PCT No.: PCT/US2022/032226

§ 371 Date: Aug. 21, 2023

Related U.S. Application Data
(60) Provisional application No. 63/196,901, filed on Jun. 4, 2021.

(51) Int. Cl. G21C 5/16; G21C 3/62; G21C 15/243

(52) U.S. Cl. CPC G21C 5/16; G21C 3/626; G21C 15/243

(57) ABSTRACT

A nuclear reactor including a nuclear reactor core. The nuclear reactor core includes a plurality of moderator elements, and an inverted fuel moderator block array of one or more inverted fuel moderator blocks. The one or more inverted fuel moderator blocks include a high-temperature matrix; a plurality of fuel particles embedded inside the high-temperature matrix; and at least one moderator opening for disposition of at least one of the moderator elements therein. The one or more inverted fuel moderator blocks also include at least one coolant passage formed in the high-temperature matrix to flow a coolant. The nuclear reactor can also include a reactivity control system, which can include one or more control drums, one or more control rods, or a combination thereof.

### CROSS-REFERENCE TO RELATED APPLICATIONS

This application is a U.S. National Phase Application of International Application No. PCT/US2022/032226, filed Jun. 3, 2022, the entirety of which is incorporated by reference herein. International Application No. PCT/US2022/032226 claims priority to U.S. Provisional Patent Application No. 63/196,901, filed on Jun. 4, 2021, titled “Fuel-Moderator Inversion for Safer Nuclear Reactors,” the entire disclosure of which is incorporated by reference herein.

### TECHNICAL FIELD

The present subject matter relates to examples of nuclear reactor systems and nuclear reactors for power production and propulsion, e.g., a terrestrial land reactor for electricity generation or nuclear thermal propulsion. The present subject matter also encompasses a nuclear reactor core architecture that includes an inverted fuel moderator block array.

### BACKGROUND

In conventional nuclear reactors, graphite blocks within the nuclear reactor are machined with coolant channels as well as fuel channels. Fuel pellets are inserted into the fuel channels with a helium backfill, and are sealed with a graphite cap. During operation of the nuclear reactor, helium runs through the graphite cooling channels to cool the reactor. During depressurization or flooding, air may enter the reactor core, potentially leading to self-sustained oxidation of the graphite, also known as a graphite fire. Graphite can undergo energy-releasing oxidation reactions if exposed to air or water: the oxidation process compromises structural integrity of the graphite. Further, during a graphite fire, unintended chemical reactions with the graphite can also create new radioactive species, which introduce further safety risk. The consequences of graphite fire are exacerbated by the presence of graphite dust. The graphite clearly poses some chemical risk.

As the graphite internally supports the core in shape and, in some reactors, protects the fuel, damage to the graphite in a conventional nuclear reactor affects the integrity of the fuel, as well as the reactor itself. In conventional reactors, fuel is the weakest component, often crumbling under irradiation damage and swelling, requiring extensive and stacked containment to prevent fission product release. However, there have been improvements in nuclear fuel technology to the stability of the fuel pellets. In particular tristructural-isotropic (TRISO) fuel particles can be dispersed in a silicon carbide matrix to form a cylindrical shaped nuclear fuel compact as described in the following patents and publications of Ultra Safe Nuclear Corporation of Seattle, Washington: U.S. Pat. No. 9,299,464, issued Mar. 29, 2016, titled “Fully Ceramic Nuclear fuel and Related Methods”; U.S. Pat. No. 10,032,528, issued Jul. 24, 2018, titled “Fully Ceramic Micro-encapsulated (FCM) fuel for CANDUs and Other Reactors”; U.S. Pat. No. 10,109,378, issued Oct. 23, 2018, titled “Method for Fabrication of Fully Ceramic Microencapsulation Nuclear Fuel”; U.S. Pat. No. 9,620,248, issued Apr. 11, 2017 and U.S. Pat. No. 10,475,543, issued Nov. 12, 2019, titled “Dispersion Ceramic Micro-encapsulated (DCM) Nuclear Fuel and Related Methods”; U.S. Patent Pub. No. 2020/0027587, published Jan. 23, 2020, titled “Composite Moderator for Nuclear Reactor Systems”; and U.S. Pat. No. 10,573,416, issued Feb. 25, 2020, titled “Nuclear Fuel Particle Having a Pressure Vessel Comprising Layers of Pyrolytic Graphite and Silicon Carbide,” the entireties of which are incorporated by reference herein.

### SUMMARY

Hence, there is room for further improvement in nuclear reactor systems 100 and nuclear reactor blocks and block arrays. A chief concern for a high-temperature gas reactor (HTGR) is graphite chemical reactivity with air and water and release of graphite dust. The Fuel-Moderator Inverted (FMI) Fuel Block (i.e., the inverted fuel moderator block) concept solves this problem by protecting the graphite or other moderator, using the fuel from, external species; and thereby increases the resilience and functionality of a nuclear reactor 107.

An inverted fuel moderator block 103B solution (see FIG. 1B) is described herein that improves the resilience of the moderator elements 150B-M to water or air presence in the nuclear reactor core 101. The inverted fuel moderator block 103B is impervious to water and air, and protects the relatively sensitive moderator elements 150B-M. This protection reduces or eliminates the chemical interaction risk posed by the graphite or other moderator, leading to a safer nuclear reactor 107.

Additionally, the inverted fuel moderator block 103B can be directly exposed to flowed coolant, which can enable the nuclear reactor core 101 to reach a lower fuel temperature during critical operation, as opposed to conventional nuclear reactors where the fuel particles 151A-N indirectly transfer heat to the flowed coolant via a moderator block. FMI technology reduces operating temperatures of the fuel particles 151A-N, which reduces the thermal and environmental stress imposed on the fuel particles 151A-N as well as a high-temperature matrix 152, improving fuel robustness and fission product retention.

The inverted fuel moderator block 103B solution can also allow for smaller coolant passage 141A-B volumes, allowing for smaller nuclear reactor cores 101 or longer-lasting nuclear reactor cores 101. Further, as the surface of the moderator elements 150B-M are not wetted by coolant in some inverted fuel moderator block 103B solutions, alternative cooling fluids are possible-potentially including air. These smaller coolant passage 141A-N volumes may allow for air breathing reactors implementing air breathing cycles via an environmental air intake and exhaust, along with reduced coolant channel volume, and can allow for lower cost and more efficient nuclear reactors.

In inverted fuel moderator block 103B solutions, the nuclear fuel in the form of the inverted fuel moderator block 103A is the highest performance component in the nuclear reactor core 101. The nuclear fuel is largely unreactive with air and water, is stable under high Displacements per Atom (DPA) and DPA rate, and is stable at high temperatures. Using nuclear fuel in the form of an inverted fuel moderator block 103A to protect a given moderator element 150A addresses problems with graphite chemical reactivity and dust, and indeed addresses any reactivity problems associated with that given moderator element 150A. Inverted fuel moderator block 103A solutions protect nuclear reactor core 101 components and reduce thermal path lengths to the coolant.

In an example, an inverted fuel moderator block 103A (see FIG. 1A) includes a high-temperature matrix 152, a plurality of fuel particles 151A-N embedded inside the high-temperature matrix 152, and at least one moderator opening 131A, such as a cavity, for disposition of at least one moderator element 150A therein.

In a second example, a nuclear reactor core 101 includes a plurality of moderator elements 150N-Z, and an inverted fuel moderator block array 113 of one or more inverted fuel moderator blocks 103A-N. The one or more inverted fuel moderator blocks 103A-N include a high-temperature matrix 152, a plurality of fuel particles 151A-N embedded inside the high-temperature matrix 152, and at least one coolant passage 141N-Z formed in the high-temperature matrix 152 to flow a coolant.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A is a three-quarter cutaway view of a generic inverted fuel moderator block, formed of a high temperature matrix and providing a moderator opening for a moderator element.

FIG. 1B is an isometric view of a hexagonal inverted fuel moderator block, with provisions for multiple moderator openings, coolant passages, and control drum channels.

FIG. 1C is a cross-sectional view of a nuclear reactor system including a nuclear reactor core implementing hexagonal inverted fuel moderator blocks with singular moderator openings and coolant passages at the interfacing corners of the inverted fuel moderator blocks.

FIG. 2 is an isometric view of an inverted fuel moderator block array formed of triangular fuel moderator blocks, the triangular fuel moderator blocks including singular moderator openings as well as faceted corners for flowing coolant.

FIG. 3A is a diagram in profile of a layered inverted fuel moderator block array including a moderator element and two plate inverted fuel moderator blocks layered above and below the moderator element.

FIG. 3B is an isometric view of the inverted fuel moderator block array of FIG. 3A.

FIG. 3C is an isometric view of a monolithic inverted fuel moderator block formed with coolant passages within the inverted fuel moderator block.

FIG. 3D is an isometric view of an inverted fuel moderator block array including a moderator element with coolant passages, multiple liner inverted fuel moderator blocks lining the coolant passages, and a border inverted fuel moderator block surrounding the moderator element.

FIG. 4A is a cross-section diagram of a triangular inverted fuel moderator block sub-assembly with a large proportion of moderator element.

FIG. 4B is an isometric view of a capped hexagonal inverted fuel moderator block assembly formed of multiple triangular inverted fuel moderator sub-assemblies as depicted in FIG. 4A.

FIG. 4C is an isometric view of the capped hexagonal inverted fuel moderator block assembly of FIG. 4B with the cap removed.

FIG. 5A is a cross-section diagram of a triangular inverted fuel moderator block sub-assembly with a small proportion of moderator element.

FIG. 5B is an isometric view of a capped triangular inverted fuel moderator block sub-assembly as depicted in FIG. 5A.

FIG. 5C is an isometric view of the capped triangular inverted fuel moderator block sub-assembly of FIG. 5B with the cap removed.

FIG. 6A is a cross-section diagram of the triangular inverted fuel moderator block sub-assembly of FIG. 5A, with three additional cut coolant passages.

FIG. 6B is a cross-section diagram of the triangular inverted fuel moderator block sub-assembly of FIG. 5A, with an additional cut ring coolant passage.

FIG. 7A is a view of an icosahedron inverted fuel moderator block sub-assembly.

FIG. 7B is a view of a polyhedron inverted fuel moderator block sub-assembly.

FIG. 7C is a view of a truncated icosahedron inverted fuel moderator block sub-assembly.

FIG. 7D is a view of a tapered triangular inverted fuel moderator block within a polyhedron of one or more triangular faces.

FIG. 7E is a view of a tapered circular inverted fuel moderator block with a convex top cap and a concave bottom cap.

FIG. 7F is a view of a tapered pentagonal inverted fuel moderator block with a tapered coolant passage.

FIG. 8 is an isometric view of an inverted fuel moderator block array formed of triangular inverted fuel moderator blocks, the triangular fuel moderator blocks including singular moderator openings as well as faceted corners for flowing coolant.

FIG. 9A is a graph of the calculated oxidation mode regions of Silicon Carbide (SiC) by Oxygen (O₂).

FIG. 9B is a graph of the calculated oxidation mode regions of Silicon Carbide (SiC) by Water (H₂O).

FIG. 10 is a chart of SiC oxidation mechanisms at high temperature.

Parts Listing

| | |
|---|---|
| 100 | Nuclear Reactor System |
| 101 | Nuclear Reactor Core |
| 103A-Z | Inverted Fuel Moderator Block |
| 113 | Inverted Fuel Moderator Block Array |
| 115A-N | Control Drums |
| 131A-Z | Moderator Openings |
| 135A-N | Control Drum Channels |
| 140 | Reflector |
| 141A-B, N-Z | Coolant Passages |
| 142 | Coolant Passage Wall |
| 150A-Z | Moderator Elements |
| 151A-N | Fuel Particles |
| 152 | High-Temperature Matrix |
| 155 | Cap |
| 156 | Nuclear Reactor Core Center |
| 157 | Nuclear Reactor Core Periphery |
| 160 | Pressure Vessel |
| 198A-F | Block Walls |
| 199A-B | Block Base |
| 203A-N | Inverted Fuel Moderator Blocks |
| 213 | Inverted Fuel Moderator Block Array |
| 231A-N | Moderator Openings |
| 253A-C | Inverted Fuel Moderator Block Interface Walls |
| 254A-C | Inverted Fuel Moderator Block Facets |
| 241A-N | Coolant Passages |
| 250A-N | Moderator Elements |
| 303A-D, O-Z | Inverted Fuel Moderator Blocks |
| 313A | Plate Inverted Fuel Moderator Block Array |
| 313C | Monolith Inverted Fuel Moderator Block Array |
| 313D | Lined Inverted Fuel Moderator Block Array |
| 341A-Z | Coolant Passages |
| 350A-B | Moderator Elements |
| 390 | Moderator Interface Wall |
| 391O-Z | Moderator Facets |
| 403A-C | Inverted Fuel Moderator Blocks |
| 413 | Hexagonal Inverted Fuel Moderator Block Assembly |
| 414A-F | Triangular Inverted Fuel Moderator Block Sub-Assembly |
| 441A-C | Coolant Passages |
| 450A-F | Moderator Elements |
| 503 | Inverted Fuel Moderator Block |
| 514 | Triangular Inverted Fuel Moderator Block Sub-Assembly |
| 641A-D | Cut Coolant Passages |
| 703A | Tapered Triangular Inverted Fuel Moderator Block |
| 703B | Tapered Circular Inverted Fuel Moderator Block |
| 703C | Tapered Pentagonal Inverted Fuel Moderator Block |
| 714A | Icosahedron Inverted Fuel Moderator Block Sub-Assembly |
| 714B | Polyhedron Inverted Fuel Moderator Block Sub-Assembly |
| 714C | Truncated Icosahedron Inverted Fuel Moderator Block Sub-Assembly |
| 741 | Tapered Coolant Passage |
| 900 | Calculated Oxidation Mode Regions of SiC by O₂ Graph |
| 901 | Calculated Oxidation Mode Regions of SiC by H₂O Graph |
| 1000 | SiC Oxidation Mechanisms at High Temperature Chart |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical or physical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +5% or as much as +10% from the stated amount. The terms “approximately” or “substantially” mean that the parameter value or the like varies up to #10% from the stated amount.

The orientations of the nuclear reactor system 100, nuclear reactor 107, nuclear reactor core 101, inverted fuel moderator blocks 103A-B, N-Z, 203A-N, 303A-D, O-Z, 403A-C, 503, 703A-C, inverted fuel moderator block arrays 113, 313A,C-D, inverted fuel moderator block assembly 413, inverted fuel moderator block sub-assemblies 414A-F, 514, 714A-C, associated components, and/or any nuclear reactor system 100 incorporating the nuclear reactor core 101 such as shown in any of the drawings, are given by way of example only, for illustration and discussion purposes. In operation for a particular nuclear reactor system 100, the components may be oriented in any other direction suitable to the particular application of the nuclear reactor system 100, for example upright, sideways, or any other orientation. Also, to the extent used herein, any directional term, such as lateral, longitudinal, up, down, upper, lower, top, bottom, and side, are used by way of example only, and are not limiting as to direction or orientation of any nuclear reactor system 100 or component of the nuclear reactor system 100 constructed as otherwise described herein.

Although A is the first letter of the alphabet and Z is the twenty-sixth letter of the alphabet, due to the restriction of the alphabet, the designation “A-Z,” “A-N,” “B-M,” and “N-Z” when following a reference number, such as 103, 131, 141, 142, etc. can refer to more than twenty-six of those identical elements. Certain elements are separated by form for ease of readability, while still retaining unity of function, such as inverted fuel moderator block array 113 and plate inverted fuel moderator block array 313A.

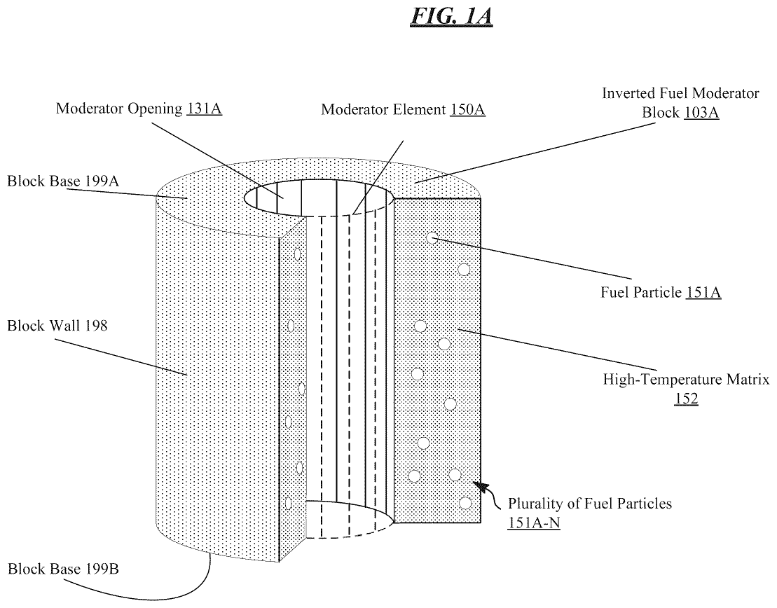

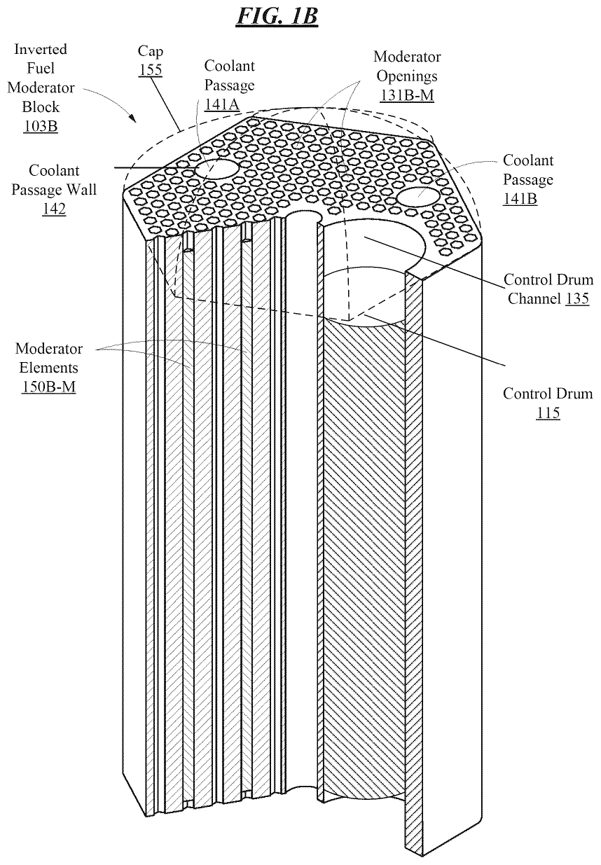

Reference now is made in detail to the examples illustrated in the accompanying drawings and discussed below. FIG. 1A is a three-quarter cutaway view of a generically-shaped, toroid inverted fuel moderator block 103A, formed of a high-temperature matrix 152 and providing a moderator opening 131A for a moderator element 150A. Generally, an inverted fuel moderator block 103A-Z is formed of a high-temperature matrix 152 that includes a plurality of fuel particles 151A-N embedded inside the high-temperature matrix 152. In the example of FIG. 1A, the fuel particles 151A-N include TRISO fuel particles. Alternatively or additionally, the fuel particles 151A-N can include bistructural-isotropic (BISO) fuel particles. TRISO-like coatings may be simplified or eliminated depending on safety implications and manufacturing feasibility. Although the fuel particles 151A-N in the example include coated fuel particles, such as TRISO fuel particles or BISO fuel particles, the fuel particles 151A-N can include uncoated fuel particles.

On the left side of FIG. 1A, the inverted fuel moderator block 103A is depicted with a cutaway section of the high-temperature matrix 152 showing the interior of the high-temperature matrix 152, as well as the fuel particles 151A-N embedded within the high-temperature matrix 152. Although the inverted fuel moderator block 103A is shown as a cylinder shape in the example, the inverted fuel moderator block 103A can be formed into a variety of different geometric shapes. For example, the inverted fuel moderator block 103A can be a tile, e.g., polygonal shape (e.g., cuboid), spheroid, or other shapes that can include a planar surface, an aspherical surface, a spherical surface (e.g., cylinder, conical, quadric surfaces), a combination thereof, or a portion thereof (e.g. a truncated portion thereof). Alternatively or additionally, the inverted fuel moderator block 103A can include one more freeform surfaces that do not have rigid radial dimensions, unlike regular surfaces, such as a planar, aspherical, or spherical surface. Further examples appear in later figures.

As an example, the inverted fuel moderator block 103A can include a plurality of lateral facets that are discontinuous to form an outer periphery of the inverted fuel moderator block 103A. As used herein, “discontinuous” means that the outer periphery formed by the lateral facets in aggregate do not form a continuous round (e.g., circular or oval) perimeter. The outer periphery includes a plurality of planar, aspherical, spherical, or freeform surfaces. As used herein, a “freeform surface” does not have rigid radial dimensions, unlike regular surfaces, such as a planar surface; or an aspherical or spherical surface (e.g., cylinder, conical, quadric surfaces).

TRISO fuel particles 151A-N are designed not to crack due to the stresses or fission gas pressure at temperatures beyond 1,600° C., and therefore can contain the nuclear fuel within in the worst of accident scenarios. TRISO fuel particles 151A-N are designed for use in high-temperature gas-cooled reactors (HTGR) and to be operating at temperatures much higher than the temperatures of light water reactors. TRISO fuel particles 151A-N have extremely low failure below 1500° C. Moreover, the presence of the high-temperature matrix 152 provides an additional robust barrier to radioactive product release.

In some implementations, the inverted fuel moderator block 103A includes bistructural-isotropic (BISO) fuel particles embedded inside the high-temperature matrix 152. In yet another implementation, the inverted fuel moderator block 103A is comprised of a variation of TRISO known as TRIZO fuel particles. A TRIZO fuel particle replaces the silicon carbide layers of the TRISO fuel particle with zirconium carbide (ZrC). Alternatively, the TRIZO fuel particle includes the typical coatings of a TRISO fuel particle and an additional thin ZrC layer coating around the fuel kernel, which is then surrounded by the typical coatings of the TRISO fuel particle. Each of the TRISO fuel particles can include a fuel kernel surrounded by a porous carbon buffer layer, an inner pyrolytic carbon layer, a binary carbide layer (e.g., ceramic layer of SiC or a refractory metal carbide layer), and an outer pyrolytic carbon layer. The refractory metal carbide layer of the TRISO fuel particles can include at least one of titanium carbide (TIC), zirconium carbide (ZrC), niobium carbide (NbC), tantalum carbide, hafnium carbide, ZrC-ZrB₂ composite, ZrC-ZrB₂—SiC composite, or a combination thereof. The high-temperature matrix 152 can be formed of the same material as the binary carbide layer of the TRISO fuel particles.

A description of TRISO fuel particles dispersed in a silicon carbide matrix to form a cylindrical shaped nuclear fuel compact is provided in the following patents and publications of Ultra Safe Nuclear Corporation of Seattle, Washington: U.S. Pat. No. 9,299,464, issued Mar. 29, 2016, titled “Fully Ceramic Nuclear fuel and Related Methods”; U.S. Pat. No. 10,032,528, issued Jul. 24, 2018, titled “Fully Ceramic Micro-encapsulated (FCM) fuel for CANDUs and Other Reactors”; U.S. Pat. No. 10,109,378, issued Oct. 23, 2018, titled “Method for Fabrication of Fully Ceramic Microencapsulation Nuclear Fuel”; U.S. Pat. No. 9,620,248, issued Apr. 11, 2017 and U.S. Pat. No. 10,475,543, issued Nov. 12, 2019, titled “Dispersion Ceramic Micro-encapsulated (DCM) Nuclear Fuel and Related Methods”; U.S. Patent Pub. No. 2020/0027587, published Jan. 23, 2020, titled “Composite Moderator for Nuclear Reactor Systems”; and U.S. Pat. No. 10,573,416, issued Feb. 25, 2020, titled “Nuclear Fuel Particle Having a Pressure Vessel Comprising Layers of Pyrolytic Graphite and Silicon Carbide,” the entireties of which are incorporated by reference herein. As described in those Ultra Safe Nuclear Corporation patents, the nuclear fuel can include a cylindrical fuel compact or pellet comprised of TRISO fuel particles embedded inside a silicon carbide matrix to create a cylindrical shaped nuclear fuel compact. A description of TRISO, BISO, or TRIZO fuel particles dispersed in a zirconium carbide matrix to form a cylindrical shaped nuclear fuel compact is provided in U.S. Patent Pub. No. 2021/0005335 to Ultra Safe Nuclear Corporation of Seattle, Washington, published Jan. 7, 2021, titled “Processing Ultra High Temperature Zirconium Carbide Microencapsulated Nuclear Fuel,” the entirety of which is incorporated by reference herein.

The fuel particle 151A is formed of an internal kernel, and at least one coating layer. The kernel can be formed of uranium carbide (UCx), thorium dioxide (ThO₂), uranium oxides (e.g., UO₂, UCO, Stabilized UO₂), uranium mononitride (UN), uranium-molybdenum (UMo) alloy, uranium-zirconium (UZr) alloy, triuranium disilicate (U₃Si_{2,5}), uranium boride (UB), uranium diboroide (UB₂), uranium gadolinium carbide nitride (UGdCN), uranium zirconium carbide nitride (UZrCN), uranium zirconium carbide (UZrC), uranium tricarbide (UC₃), uranium zirconium niobium carbide (UZrNbC), molten fuel in a carbon kernel (i.e., infiltrated kernel), composites (e.g., uranium-dioxide-molybdenum (UO₂Mo) alloy, uranium nitride/triuranium disilicate (UN/U₃Si₂), or triuranium disilicate/uranium diboride (U₃Si₂/UB₂)), dopants (e.g. chromium oxide (Cr₂O₃)), other fissile and fertile fuels, or any combination thereof. The kernel can be spherical, a composite, or formed of nanofibers.

Each of the fuel particles 151A-N can include a porous carbon buffer layer surrounding the internal kernel, an inner pyrolytic carbon layer, a binary carbide layer (e.g., ceramic layer of SiC or a refractory metal carbide layer), and an outer pyrolytic carbon layer: each layer constituting the at least one coating layer. The refractory metal carbide layer of the fuel particles 151A-N can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The fuel particles 151A-N can be between 100 and 2000 micron, with multiple size populations (e.g., 100 microns, 700 microns, 2000 microns) to enhance packing fraction of fuel particles 151A-N.

The at least one coating layer can be formed of pyridine carbide (PyC), silicon carbide (SiC), zirconium carbide (ZrC), zirconium diboride (ZrB₂), niobium carbide (NbC), titanium carbide (TiC), tantalum carbide (TaC), titanium nitride (TiN), boron carbide (B₄C), beta-decayed silicon nitride (β-Si₃N₄), SiAlON ceramics, or any combination thereof.

The high-temperature matrix 152 may be formed of silicon carbide (SiC), which has excellent chemical stability in the presence of air and water in repository conditions but also at temperatures of the nuclear reactor 107. If SiC is not sufficiently high performance, another high-temperature matrix 152 material such as zirconium carbide (ZrC) can also be used. Some examples of high-temperature matrix 152 materials include silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or any combination thereof.

The moderator element 150A may be formed of graphite, zirconium hydride (ZrH), yttrium hydride (YH), known composite moderators, known moderators in steel cans or any other type of cladding such as an SiC—SiC matrix composite. The moderator element 150A may be clad in a protective substance, or the inverted fuel moderator block 103A may act as the structural containment for the moderator element 150A. Composite moderators can protect the moderator element 150A from coolant and can serve as structural containment for 2-phase moderators. A composite moderator is formed of two or more moderators, including a low moderating material and a high moderating material. The high moderating material has a higher neutron slowing down power compared to the low moderating material. The low moderating material includes a moderating matrix of silicon carbide (SiC) or magnesium oxide (MgO). The high moderating material is dispersed within the moderating matrix and includes beryllium (Be), boron (B), or a compound thereof. Such a composite moderator does not rely upon the inverted fuel moderator block 103A for protection. Such composite moderators use an intentional and additional structural and non-nuclear material such as MgO, SiC, or ZrC to make a matrix that encapsulates spheres of moderator, and which takes up valuable volume in the nuclear reactor core 101. Therefore, avoiding using such composite moderators within the moderator element 150A can be beneficial.

The inverted fuel moderator block 103A of FIG. 1A has been additively manufactured to contain cavities or moderator openings 131A for moderator elements 150A or blocks. Instead of a traditional graphite moderator block with fuel particles placed within a fuel opening or fuel channel, the inverted fuel moderator block 103A may have moderator elements 150A placed within a moderator opening 131A or moderator channel. Further, the moderator elements 150A may be sealed within the moderator opening 131A of the inverted fuel moderator block 103A, with one or more caps 155 placed over one or more moderator openings 131A. By sealing a moderator element 150A within an inverted moderator fuel block 103A, the inverted fuel moderator block 103A (and consequently the constituent fuel particles 151A-N) protect the moderator element from any external species, as opposed to in a conventional moderator block where the conventional moderator block protects the fuel particles from any external species. Sealing the moderator element 150A within the inverted fuel moderator block 103A imbues the inverted fuel moderator block 103A with a dual use: acting as a heat-generating fuel, as well as a moderator element 150A protection layer.

In some circumstances, “sealing” a moderator element 150A within an inverted fuel moderator block 103A may constitute providing an absolute vacuum barrier from the moderator element 150A to any external species or coolant via the inverted fuel moderator block 103A. A moderator element 150A may nevertheless be sufficiently “sealed” within an inverted fuel moderator block 103A if the inverted fuel moderator block 103A prevents intentional or incidental exposure of the moderator element 150A to a flowed, liquid coolant.

Additionally, though sealing the moderator element 150A within the inverted fuel moderator block 103A is particularly advantageous, simply reducing the wetted surface area of the moderator element 150A is beneficial. Thin coatings such as chemical vapor deposition (CVD) SiC can also be used to offer some protection. As the inverted fuel moderator block 103A lowers the number of wetted materials, there will be many compatible coolants such as molten salts, air, carbon dioxide (CO₂), nitrogen (N₂), hydrogen (H₂), liquid metals, or organic liquids. Inverted fuel moderator blocks 103A may also find uses in high performance nuclear reactors 107 like air breathing ram jets, space reactors, and nuclear thermal propulsion systems in space.

Many different methods for ceramic matrix production may be used to create an inverted fuel moderator block 103A including fuel particles 151A-N and a moderator element 150A, such as 3D additive manufacturing, sintering (including pressureless, hot isostatic pressing, spark plasma sintering), machining, or chemical vapor infiltration (CVI). However, as manufacturing inverted fuel moderator blocks 103A can be difficult without additive manufacturing and CVI, consider a manufacturing process utilizing 3D additive manufacturing and CVI. Such a manufacturing process entails: first, manufacturing the block bases 199A-B and block wall 198 or block walls 198A-N of the inverted fuel moderator block 103A. The block bases 199A-B and block wall 198 will form with cavities for fuel particles 151A-N and separate cavities or moderator openings 131A for moderator elements 150A. In this depicted example, the cavities for fuel particles 151A-N are approximately the size of the fuel particles 151A-N and are stochastically distributed throughout the inverted fuel moderator block 103A. But the fuel particles 151A-N can be distributed in a uniform manner, or can be distributed in rows, columns, planes, or other patterns throughout the inverted fuel moderator block 103A. In particular, if distributed in one or more contiguous volumes, such as within a column, the fuel particles 151A-N may be further stored within an additional compact material, conforming to the shape of the one or more contiguous volumes. In further detail, this step can include providing a powder feedstock of silicon carbide, and then selectively depositing a binder onto successive layers of the powder feedstock to produce a dimensionally stable object of greater than 30% by weight of silicon carbide.

Manufacturing the block bases 199A-B and block wall 198 can be performed via 3D additive manufacture using binder jetting, but other additive manufacturing methods or traditional manufacturing methods for the block are possible. The inverted fuel moderator block 103A can be formed using any type of additive manufacturing method appropriate for the material being used (e.g. binder jetting for ceramics, or laser-based system manufacturing for metals and ceramics). Once the cavities for fuel particles 151A-N are formed within the inverted fuel moderator block 103A, then the fuel particles 151A-N are placed within those cavities.

Next, there are two different methods for securing the fuel particles 151A-N and moderator element 150A. The first method, the results of which constitute the inverted fuel moderator block 103A of FIG. 1, is often used when the moderator element 150A is a large, monolithic element of moderator material, and is performed as follows. First, CVI is used to create the high-temperature matrix 152 around the fuel particles 151A-N. The moderator opening 131A is preserved during this CVI process. Next, a moderator element 150A is placed within the moderator opening 131A within the high-temperature matrix 152 in the inverted fuel moderator block 103A. Finally, the moderator opening 131A is sealed using high-temperature matrix 152 bonding techniques, threaded caps, or additional CVI can deposit more or different materials to form a seal.

The second method varies from the first method in ordering. In the second method, before CVI is performed, the moderator element 150A is placed within the moderator opening 131A. This second method can be used when the moderator element 150A is broken into many smaller moderator elements, potentially as small or smaller than the fuel particles 151A-N. The moderator opening 131A in these examples conforms to the size of the moderator elements, and therefore may be as small or smaller than the cavities of the fuel particles 151A-N. Such moderator elements 150A can have many different shapes from small spheres (100-2000 microns) to macro sized rods or prisms to minimize machining effort. Finally, the CVI process creates a high-temperature matrix 152 around both the fuel particles 151A-N and the moderator element 150A or elements. The second method essentially results in the inverted fuel moderator block 103A formed with fuel particles 151A-N and moderator element 150A particles simultaneously. Instead of the moderator opening 131A presenting as a large exposed cavity for the moderator element 150A, the moderator element 150A particles (and consequently the moderator openings 131A in which they reside) are embedded within the high-temperature matrix 152. The clumping of fuel particles 151A-N versus moderator element 150A particles is controlled by how the fuel particles 151A-N and the moderator element 150A particles are first placed into the printed cavities, prior to the CVI processing step.

The CVI process can involve positioning the inverted fuel moderator block 103A within a CVI reactor and elevating the temperature therein, thereby debinding the inverted fuel moderator block 103A. Next, it can involve introducing within the CVI reactor a precursor gas including silicon and a hydrocarbon while at an elevated temperature, such that a breakdown of the precursor gas at the elevated temperature causes silicon carbide to infiltrate the inverted fuel moderator block 103A and seal the inverted fuel moderator block 103A with a densified outer layer. The inverted fuel moderator block 103A would include a substantially pure silicon carbide microstructure and high heat resistance with a density of greater than 85% by weight of silicon carbide.

The inverted fuel moderator block 103A may include poisons, such as neutron poisons and oxygen getters, for the purposes chemical control, manufacturing aid, and property tuning.

FIG. 1B is an isometric view of a hexagonal inverted fuel moderator block 103B, with provisions for multiple moderator openings 131B-M, coolant passages 141A-B, and control drum channels 135. In this example, the inverted fuel moderator block 103B has been manufactured with many moderator openings 131B-M within the high-temperature matrix 152. Once the moderator elements 150B-M are inserted in the moderator openings 131B-M, the inverted fuel moderator block 103B can be sealed using high-temperature matrix 152 bonding techniques, threaded caps, or additional CVI can deposit more or different material to form a seal or cap 155.

The inverted fuel moderator block 103B further includes a control drum channel 135 with a control drum 115 disposed longitudinally within the inverted fuel moderator block 103B and laterally surrounding the plurality of fuel particles 151A-N embedded in the high-temperature matrix 152 and the moderator elements 150B-M, in order to control reactivity of the inverted fuel moderator block 103B, and any nuclear reactor core 101 within which the inverted fuel moderator block 103B is placed. A control drum 115 includes a reflector material on a first portion of an outer surface of the control drum 115 and an absorber material on a second portion of the outer surface of the control drum 115. Burnable poison can be integrated within the inverted fuel moderator block 103B to shut down the nuclear reactor core 101 in an emergency.

A control drum 115 regulates the neutron population in the inverted fuel moderator block 103B, the nuclear reactor core 101, and nuclear reactor 107 (see FIG. 1C) power level like control rods in other nuclear reactor systems. An inverted fuel moderator block 103B with a control drum 115 may also control reactivity of other inverted fuel moderator blocks 103C-N within a nuclear reactor core 101 which do not include control drums 115C-N. To increase or decrease neutron flux in the nuclear reactor core 101, the control drum 115 is rotated by a reactivity control system; whereas control rods are inserted or removed from the nuclear reactor core 101 by a reactivity control system. Because a control drum 115 is rotated to adjust reactivity of the nuclear reactor core 101 instead of being inserted and removed, a control drum 115 has a permanently fixed longitudinal position. Control drum 115 does not move in or out of the nuclear reactor core 101 or the inverted fuel moderator block 103B. There are risks that control rods may not insert fully into the nuclear reactor core 101 due to misalignment or blockages in a control rod channel, and utilizing a control drum 115 advantageously reduces those risks. Control rods nevertheless could be utilized along with control rod channels in lieu control drum channels 135A-N.

The first portion of an outer surface of a control drum 115 includes a reflector material, which is generally formed of a material with a high elastic scattering neutron cross section. When the reflector material faces inwards towards the nuclear reactor core center 156, the neutron flux increases, which increases the reactivity and operating temperature of the nuclear reactor core 101. The second portion of the outer surface of a control drum 115 includes an absorber material, which can be formed of a neutron poison. Neutron poisons are isotopes or molecules with a high absorption neutron cross section particularly suited to absorbing free neutrons. When the absorber material faces inwards towards the nuclear reactor core center 156 (see FIG. 1C), the neutron flux of the nuclear reactor core 101 decreases, which decreases the reactivity and operating temperature of the nuclear reactor core 101.

A nuclear reactor system 100 (see FIG. 1C) implementing one or more control drums 115A-N can selectively rotate a control drum 115 or a plurality of control drums 115A-N to face either the absorber material towards the nuclear reactor core center 156 (see FIG. 1C), decreasing neutron flux and operating temperature; or the reflector material towards the nuclear reactor core center 156, increasing neutron flux and operating temperature. Therefore, the nuclear reactor system 100 can selectively increase or decrease neutron flux of the nuclear reactor core 101, and consequently neutron flux of the inverted fuel moderator block 103B within the nuclear reactor core 101. To rapidly decrease neutron flux and achieve a decreased flux state, the nuclear reactor system 100 can rotate a control drum 115 to maximally expose the absorber material of the control drum 115 to the fuel particles 151A-N of the inverted fuel moderator block 103B, thereby absorbing more free neutrons and decreasing neutron flux. The distribution of the fuel particles 151A-N may not be normal throughout the inverted fuel moderator block 103B, the control drum 115 may not be centered within the inverted fuel moderator block 103B, or the density of fuel particles 151A-N across multiple inverted fuel moderator blocks 103N-Z may not be normally distributed relative to the control drum 115, thereby creating a relatively high-density area of fuel particles 151A-N and a relatively low-density area of fuel particles 151A-N from the perspective of the control drum 115. To rapidly increase neutron flux and achieve an increased flux state, the nuclear reactor system 100 can rotate a control drum 115 to maximally expose the reflector material of the control drum 115 to the fuel particles 151A-N of the inverted fuel moderator block 103, thereby reflecting more free neutrons and increasing neutron flux. To make an intermediate adjustment or sustain a continuous level of neutron flux, the nuclear reactor core 100 can rotate a control drum 115 to a partial exposure of the absorber material of the control drum 115 to the fuel particles 151A-N of the inverted fuel moderator block 103B.

Partial or full exposure of the reflector material can move the nuclear reactor 107 to a critical state, and a sustained critical state will induce an active state. When the nuclear reactor 107 containing the inverted fuel moderator block 103B is in an active state, the nuclear reactor 107 is producing an optimal amount of heat and therefore electricity, as well as a high level of free neutrons that may escape the nuclear reactor core 101.

Partial or full exposure of the absorber material, or the materially complete consumption of the fuel particles 151A-N, will move the nuclear reactor 107 to a sub-critical state. A sustained sub-critical state will induce an inactive state. When the nuclear reactor 107 containing the inverted fuel moderator block 103B is in an inactive state, the nuclear reactor 107 is producing a minimal amount of heat, and very likely no electricity. The nuclear reactor 107 in the inactive state is also producing a minimal amount of free neutrons that may escape the nuclear reactor core 101.

FIG. 1C is a cross-sectional view of a nuclear reactor system 100 including a nuclear reactor core 101 implementing an inverted fuel moderator block array 113 of hexagonal inverted fuel moderator blocks 103N-Z with singular moderator openings 131N-Z and coolant passages 141N-Z at the interfacing corners of the inverted fuel moderator blocks 103N-Z.

The inverted fuel moderator blocks 103N-Z share features of the inverted fuel moderator block 103A of FIG. 1A, and the inverted fuel moderator block 103B of FIG. 1B. The inverted fuel moderator blocks 103N-Z have the hexagonal face shape of the inverted fuel moderator block 103B of FIG. 1B, while each implementing a singular moderator opening 131N-Z in each inverted fuel moderator block 103N-Z like the inverted fuel moderator block 103A of FIG. 1A, rather than multiple moderator openings 131B-M like the inverted fuel moderator block 103B of FIG. 1B. Both styles of inverted moderator block 103A-B and moderator opening 150A-M may be combined as required by the nuclear reactor system 100 design.

In this inverted fuel moderator block array 113, at the junction of inverted fuel moderator blocks 103N-Z, a coolant passage 141N-Z is formed. The coolant passages 141N-Z may fully encompass the block wall 198 of each inverted fuel moderator block 103N-Z, or various cavities of the inverted fuel moderator block 103N-Z can be introduced (preferably at manufacturing time) to facilitate coolant passages 141N-Z. Further detail on coolant passages appears in later figures. This design and the designs of coolant passages in later figures can lower fuel temperatures during operations, due to fuel particles 151A-N being in direct contact with coolant, rather than indirectly transmitting heat through a moderator element 150B. Consequently, coolant path lengths can be reduced by up to a factor of five or more, based on a typical thermal reactor coolant moderator ratio of five.

The nuclear reactor 107 of the nuclear reactor system 100 has a pressure vessel 160. The pressure vessel 160 exterior may be treated with a coating, or forged or manufactured with particular metals or chemicals in order to further reduce corrosion or oxidation experienced by modular reactors submerged in moderating fluids (e.g., water or more complex fluids).

The nuclear reactor 107 includes a reflector 140 (e.g., an outer reflector region) located inside the pressure vessel 160. Reflector 140 includes a plurality of reflector blocks laterally surrounding the inverted fuel moderator block array 113.

Nuclear reactor 107 includes the nuclear reactor core 101, in which a controlled nuclear chain reaction occurs, and energy is released. The neutron chain reaction in the nuclear reactor core 101 is critical—a single neutron from each fission nucleus results in fission of another nucleus—the chain reaction must be controlled. By sustaining controlled nuclear fission, the nuclear reactor system 100 produces heat energy. In an example implementation, the nuclear reactor system 100 is implemented as a gas-cooled high temperature nuclear reactor 107. However, the nuclear reactor system 100 can be implemented as a heat pipe nuclear reactor, molten-salt-cooled nuclear reactor, helium-cooled nuclear reactor, graphite moderated nuclear reactor, fuel-in-salt nuclear reactor, a supercritical CO₂ reactor, an (open or closed) Brayton cycle reactor, or a sodium-cooled fast nuclear reactor. In particular, the nuclear reactor system 100 can be implemented with a gas-cooled graphite-moderated nuclear reactor, a fluoride salt-cooled high-temperature nuclear reactor with a higher thermal neutron flux than the gas-cooled graphite-moderated nuclear reactor, or a sodium fast nuclear reactor with a faster neutron flux than the gas-cooled graphite-moderated nuclear reactor.

The nuclear fuel retains fission products within itself, reducing the immediate need to dispose of nuclear waste products. The coated fuel particles also reduce proliferation risk as compared to commercial light water reactor fuel.

Although not shown, nuclear reactor core 101 can include an insulator element array of insulator elements. Insulator elements are formed of a high-temperature thermal insulator material with low thermal conductivity. The high-temperature thermal insulator material can include low density carbides, metal-carbides, metal-oxides, or a combination thereof. More specifically, the high-temperature thermal insulator material includes low density SiC, stabilized zirconium oxide, aluminum oxide, low density ZrC, low density carbon, or a combination thereof. Moderator elements 103A-N are formed of a low-temperature solid-phase moderator. The low-temperature solid-phase moderator can include MgHₓ, YHₓ, ZrHₓ, CaHₓ, ZrOₓ, CaOₓ, BeOₓ, BeCₓ, Be, enriched boron carbide, ¹¹B₄C, CeHₓ, LiHₓ, or a combination thereof.

In this nuclear reactor system 100, the nuclear reactor 107 can include a plurality of control drums 115 and a reflector 140. The control drums 115A-N may laterally surround the inverted fuel moderator block array 113 to change reactivity of the nuclear reactor core 101 by rotating the control drums 115. Control drums 115 can reside on the perimeter or periphery of a pressure vessel 160 and can positioned circumferentially around the inverted fuel moderator block array 113 of the nuclear reactor core 101. Control drums 115 may be located in an area of the reflector 140, e.g., an outer reflector region formed of reflector blocks immediately surrounding the nuclear reactor core 101, to selectively regulate the neutron population and reactor power level during operation. For example, control drums 115A-N can be a cylindrical shape and formed of both a reflector material (e.g., beryllium (Be), beryllium oxide (BeO), BeSiC, BeMgO, Al₂O₃, etc.) on a first portion of an outer surface and an absorber material on a second portion of the outer surface (e.g., outer circumference).

The reflector material and the absorber material can be on opposing sides of the cylindrical shape, e.g., portions of an outer circumference, of a control drum 115. The reflector material can include a reflector substrate shaped as a cylinder or a truncated portion thereof. The absorber material can include an absorber plate or an absorber coating. The absorber plate or the absorber coating are disposed on the reflector substrate to form the cylindrical shape of the control drum 115. For example, the absorber plate or the absorber coating covers the reflector substrate formed of the reflector material to form the control drum 115. When the reflector material is the truncated portion of the cylinder, the absorber material is a complimentary body shape to the truncated portion to form the cylindrical shape.

Control drums 115A-N can be formed of a continuous surface, e.g., rounded, aspherical, or spherical surfaces to form a cylinder or other conical surfaces to form a quadric surface, such as a hyperboloid, cone, ellipsoid, paraboloid, etc. Alternatively or additionally, control drums 115A-N can be formed of a plurality of discontinuous surfaces (e.g., to form a cuboid or other polyhedron, such as a hexagonal prism). As used herein, “discontinuous” means that the surfaces in aggregate do not form a continuous outer surface that is round (e.g., circular or oval) perimeter of the control drums 115A-N.

Rotating cylindrical-shaped control drums 115A-N changes proximity of the absorber material (e.g., boron carbide, B₄C) of the control drums 115A-N to the nuclear reactor core 101 to alter the amount of neutron reflection. When the reflector material is inwards facing towards the nuclear reactor core 101 and the absorber material is outwards facing, neutrons are scattered back (reflected) into the nuclear reactor core 101 to cause more fissions and increase reactivity of the nuclear reactor core 101. When the absorber material is inwards facing towards the nuclear reactor core 101 and the reflector material is outwards facing, neutrons are absorbed and further fissions are stopped to decrease reactivity of the nuclear reactor core 101.

Neutron reflector 140, e.g., shown as the outer reflector region, can be filler elements disposed between outermost inverted fuel moderator blocks 103N-Z and control drums 115A-N as well as around control drums 115A-N. Reflector 140 can be formed of a moderator that is disposed between the outermost inverted fuel moderator blocks 103N-Z and an optional barrel (e.g., formed of beryllium). The reflector 140 can include hexagonal or partially hexagonal shaped filler elements and can be formed of a neutron moderator (e.g., beryllium oxide, BeO). Although not required, nuclear reactor 107 can include the optional barrel (not shown) to surround the inverted fuel moderator block array 113 of the nuclear reactor core 101, as well as the reflector 140. Control drums 115A-N can reside on the perimeter of the pressure vessel 160 and can be interspersed or disposed within the reflector 140, e.g., surround a subset of the filler elements (e.g., reflector blocks) forming the reflector 140.

Pressure vessel 160 can be formed of aluminum alloy, carbon-composite, titanium alloy, a radiation resilient SiC composite, nickel-based alloys (e.g., Inconel™ or Haynes™), or a combination thereof. Pressure vessel 160 and nuclear reactor system 100 can be comprised of other components, including cylinders, piping, and storage tanks that transfer a moderator coolant that flows through inverted fuel moderator block 103N-Z coolant passages 141N-Z. The coolant passages 141N-Z are flattened ring shaped (e.g., O-shape) openings, such as a channels or holes to allow the coolant to pass through in the nuclear reactor core 101. Preferably, the coolant passages 141N-Z minimize contact with and thereby wetting of the moderator elements 150N-Z.

The coolant that flows through the coolant passages 141N-Z can include helium, FLiBe molten salt formed of lithium fluoride (LiF), beryllium fluoride (BeF₂), sodium, He, HeXe, CO₂, neon, or HeN.

In traditional prismatic gas reactors, graphite blocks are machined with coolant channels and fuel channels. Fuel pellets are inserted into the fuel channels with a helium backfill, and sealed with a graphite cap. During operations, helium runs through the graphite cooling channels to cool the reactor. In the event of depressurization or flooding, air may enter the reactor core potentially leading to self-sustained oxidation of the graphite, also known as a graphite fire. Graphite will undergo energy-releasing oxidation reactions if exposed to air or water, compromising its structural integrity which internally supports the core in shape and, in some reactors, protects the fuel. The chemical reactions with graphite can also create new species with further safety risk. The problem is exacerbated by the presence of graphite dust, one of the problems associated with pebbled bed gas reactors. The nuclear reactor system 100 of FIG. 1C reduces this chemical risk.

FIG. 2 is an isometric view of an inverted fuel moderator block array 213 formed of triangular fuel moderator blocks 203A-N. The triangular fuel moderator blocks 203A-N include singular moderator elements 250A-N in moderator openings as well as faceted vertices for flowing coolant.

The inverted fuel moderator block array 213 is functionally and chemically very similar to the inverted fuel moderator block array 113 of FIG. 13. However, instead of hexagonal inverted fuel moderator blocks 103N-Z, triangular inverted fuel moderator blocks 203A-N are utilized. Additionally, the inverted fuel moderator blocks 203A-N have dedicated inverted fuel moderator block facets 254A-C for flowing coolant. In the example of FIG. 1C, coolant can be flowed over each of the six block walls 198-F of the inverted fuel moderator blocks 103N-Z. In this example, the triangular inverted fuel moderator blocks 203A-N have their walls 198-F divided into two sub-groups: inverted fuel moderator block interface walls 253A-C, and inverted fuel moderator block facets 254A-C. The inverted fuel moderator block interface walls 253A-C of a given inverted fuel moderator block 203A contact the inverted fuel moderator block interface walls 253A-C of a neighboring inverted fuel moderator block 203B. However, the inverted fuel moderator block facet 254A of a first inverted fuel moderator block 203A, the inverted fuel moderator block facet 254B of a second inverted fuel moderator block 203B, and the inverted fuel moderator block facet 254C of a third inverted fuel moderator block 203C all meet at a singular point. Those three inverted fuel moderator facets 254A-C border each other to collectively form a coolant passage 241A. Although each individual inverted fuel moderator block 203A-N of the inverted fuel moderator block array 213 does not fully encompass a single coolant passage 241A, collectively the inverted fuel moderator block array 213 encompasses multiple coolant passages 241A-N.

Inverted fuel moderator block facets 254A-C appear to an observer as a curved surface or a flat surface like a cut gemstone with many facets. A “facet” can be a flattened segment (e.g., planar surface) or curved segment (e.g., aspherical or spherical surface). The multiple inverted fuel moderator block facets 254A-C form a discontinuous (e.g., non-uniform or jagged) outer periphery of an inverted fuel moderator block 203A. Inverted fuel moderator block interface walls 253A-C include a section of the outer periphery that the outer periphery is divided into. The inverted fuel moderator block interface walls 253A-C can be formed of one facet (single faceted) like the block wall 198 of FIG. 1A or multiple facets (multi-faceted).

As used herein, “discontinuous” means that the outer periphery formed by the inverted fuel moderator block interface walls 253A-C and the inverted fuel moderator block facets 254A-C in aggregate do not form a continuous round (e.g., circular or oval) perimeter. The outer periphery of the inverted fuel moderator block 203A includes a plurality of planar, aspherical, spherical, or freeform surfaces. As used herein, a “freeform surface” does not have rigid radial dimensions, unlike regular surfaces, such as a planar surface; or an aspherical or spherical surface (e.g., cylinder, conical, quadric surfaces).

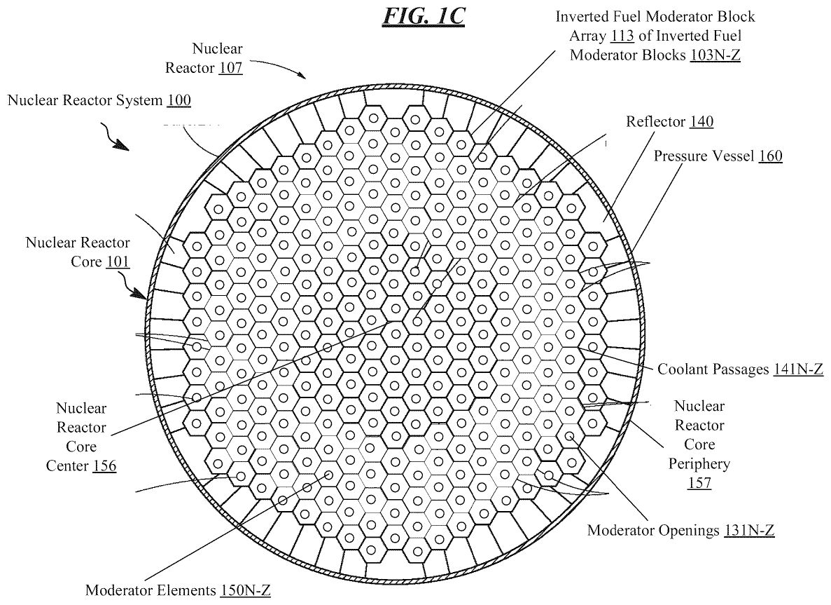

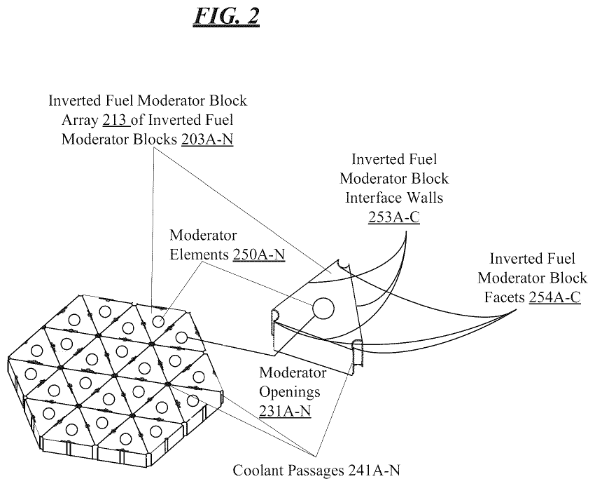

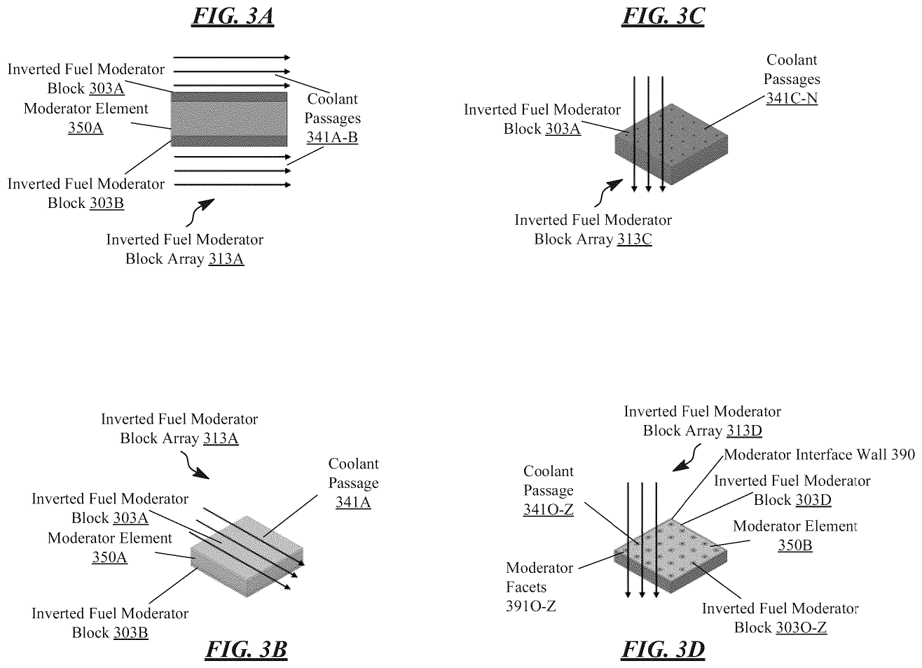

FIGS. 3A-D depict alternative structural formats for inverted fuel moderator blocks 303A-D,O-Z. Chemically and functionally, these inverted fuel moderator blocks 303A-D,O-Z are substantially similar to the inverted fuel moderator blocks 103A,B,N-Z, 203A-N previously presented. FIG. 3A is a diagram in profile of a layered inverted fuel moderator block array 313 including a moderator element 350A and two plate inverted fuel moderator blocks 303A-B layered above and below the moderator element 350A. In this example, a plate or wafer is formed by first placing a bottom layer or plate of inverted fuel moderator block 303B. Next, a moderator element 350A layer or plate is placed above the bottom layer of inverted fuel moderator block 303B. Finally, a top layer or plate of inverted fuel moderator block 303B is placed above the moderator element 350A. In this example, no coolant channels are formed within the inverted moderator blocks 303A-B or moderator element 350A. Rather, coolant flows like a continuous body of fluid through a planar coolant passage 341A over the top of the top inverted fuel moderator block 303A, and through another planar coolant passage 341B below the bottom of the bottom inverted fuel moderator block. The coolant does not come into direct contact with the moderator element 350A. Though not depicted, the sides of the moderator element 350A can be protected from the coolant by additional inverted fuel moderator blocks, or by the pressure vessel 160 of the nuclear reactor 107. FIG. 3B is an isometric view of the inverted fuel moderator block array 313A of FIG. 3A, and further shows how the coolant flows over the top of the inverted fuel moderator block array 313A, and not around the sides where coolant might contact the moderator element 350A.

FIG. 3C is an isometric view of a monolithic inverted fuel moderator block 303C formed with coolant passages 341C-N within the inverted fuel moderator block 303C. Several coolant passages 341C-N have been formed directly within the inverted fuel moderator block 303C in order to flow coolant closely to the fuel particles 151A-N. This particular inverted fuel moderator block 303C may either not include a moderator element. Or any moderator elements are embedded within the inverted fuel moderator block 303C, using a method similar to the second method of for securing the fuel particles 151A-N and moderator element 150A presented in the description of FIG. 1A.

FIG. 3D is an isometric view of an inverted fuel moderator block array 313D including a moderator element 350B with coolant passages 341O-Z, multiple liner inverted fuel moderator blocks 303O-Z lining the coolant passages 341O-Z, and a border inverted fuel moderator block 303D surrounding the moderator element 350B. This example is similar to the example of FIG. 3C, except that any existing moderator is in the form of a moderator element 350B. The moderator element 350B has been formed with coolant passages 341O-Z to flow coolant. In order to prevent wetting of the moderator element 350B, each coolant passage 341O-Z is lined with a complementing inverted fuel moderator block 303O-Z. This complementing inverted fuel moderator block 303O-Z is generally shaped like a thick straw, allowing coolant to flow through the coolant passages 341O-Z while still protecting the moderator element 350C from wetting. The entire moderator element 350B is also surrounded by a bordering inverted fuel moderator block 303D to protect from wetting or dust on the sides of the moderator element 350B.

Each of FIGS. 3A-D represent a three-dimensional object. Any face of the three-dimensional object where moderator elements 350A-B are exposed may be covered by nonreactive material such as insulators or the pressure vessel, or may be covered or capped by additional inverted fuel moderator blocks. FIGS. 3A-D also illustrate that the moderator element 350A-B does not need to be a simple cylinder. In particular, the moderator element 350B is a complex piece, with a rectangular parallelepiped exterior forming moderator interface walls 390, and moderator facets 3910-Z interfacing with the inverted fuel moderator blocks 303O-Z forming a sleeve to protect the moderator element 350B from wetting. The moderator interface walls 390 may take any form or structure that an inverted fuel moderator interface wall 253A-C may take, and the moderator facets 3910-Z may take any form or structure that an inverted fuel moderator facet 254A-C may take.

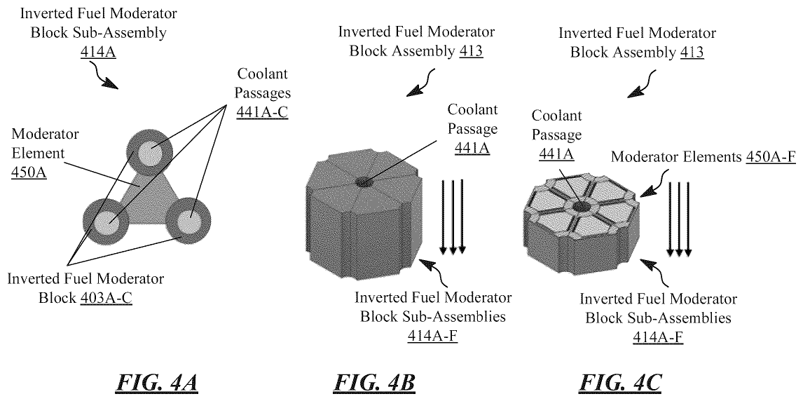

FIG. 4A is a cross-section diagram of a triangular inverted fuel moderator block sub-assembly 414A with a large proportion of moderator element 450A. In this diagram, in order to maintain a relatively large proportion of moderator element 450A, the inverted fuel moderator blocks 403A-C are maintained at the vertices of the triangular moderator element 450A. Each inverted fuel moderator block 403A-C of the diagram contains a coolant passage 441A-C.

FIG. 4B is an isometric view of a capped hexagonal inverted fuel moderator block assembly 413 formed of multiple triangular inverted fuel moderator block sub-assemblies 414A-F as depicted in FIG. 4A. The diagram in in FIG. 4A shows the functional relationship between coolant, fuel, and moderator. FIG. 4B shows instead how the physical elements interact. First, a particular inverted fuel moderator sub-assembly 414A does not maintain three full coolant passages 441A-C. Rather, each fuel moderator block sub-assembly 414A-F maintains one-sixth each of three coolant passages 441A-C. As the inverted fuel moderator block sub-assemblies 414A-F are brought together to form the inverted fuel moderator block assembly 413, each of their one-sixth coolant passages 441A meet to form a full coolant passage 441A. As the inverted fuel moderator block assembly 413 is installed adjacent to at least two other inverted fuel moderator block assemblies 413, another full coolant passage 441B is formed at the meeting of six one-sixth coolant passages 441B. The pattern is similar to the hexagonal pattern of inverted fuel moderator blocks 103N-Z of FIG. 1C. Each inverted fuel moderator block assembly 413 further implements the inverted fuel moderator block interface walls 253A-C and inverted fuel moderator block facets 254A-C of FIG. 2 in a hexagonal orientation. Each inverted fuel moderator block sub-assembly 414A-F is depicted with a cap 155, which protects the moderator elements 450A-F from wetting and dust.

FIG. 4C is an isometric view of the capped hexagonal inverted fuel moderator block assembly 413 of FIG. 4B with the cap 155 removed. FIG. 4C more explicitly depicts that each of the inverted fuel moderator block sub-assemblies 414A-F presents only one-sixth of the coolant passage wall 142 (see FIG. 1B) of the coolant passage 441A. FIG. 4C also depicts the internal moderator elements 450A-F, protected on all sides (except the removed cap 155) by inverted fuel moderator block assembly 413.

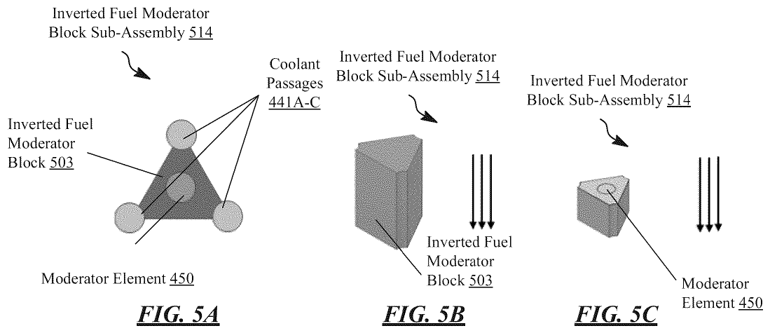

FIG. 5A is a cross-section diagram of a triangular inverted fuel moderator block sub-assembly 514 with a small proportion of moderator elements. In this diagram, in order to maintain a relatively small proportion of moderator element, the inverted fuel moderator block 503 encompasses a smaller moderator element 450, and maintains three one-sixth coolant passages 441A-C at the vertices of the triangular inverted fuel moderator block 503, in a similar fashion to the inverted fuel moderator block sub-assembly 413A of FIG. 4A.

FIG. 5B is an isometric view of a capped triangular inverted fuel moderator block sub-assembly 514 as depicted in FIG. 5A. FIG. 5C is an isometric view of the capped triangular inverted fuel moderator block sub-assembly 514 of FIG. 5B with the cap 155 removed. A nuclear reactor core 101 can include both the inverted fuel moderator block sub-assembly 514 and the inverted fuel moderator block sub-assembly 414A in order to form a full inverted fuel moderator block assembly, as well as in order to form a full inverted fuel moderator block array. As the shapes and coolant passages are compatible, the two inverted fuel moderator block sub-assemblies 414A, 514 may be interchanged to meet the requirements of the nuclear reactor system 100.

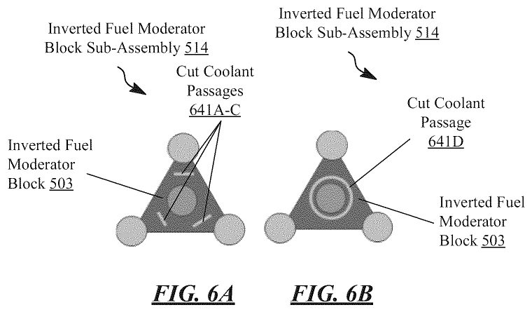

FIG. 6A is a cross-section diagram of the triangular inverted fuel moderator block sub-assembly 514 of FIG. 5A, with three additional cut coolant passages 641A-C. The cut coolant passages 641A-C may be in any shape or orientation, and may vary in diameter and volume. The cut coolant passages 641A-C may be “cut” into the inverted fuel moderator block 503, but it is preferred to instead form the cut coolant passages 641A-C at the time of manufacturing the inverted fuel moderator block 503. FIG. 6B is a cross-section diagram of the triangular inverted fuel moderator block sub-assembly 514 of FIG. 5A, with an additional cut ring coolant passage 641D. FIG. 6B further shows that a cut coolant passage 641D can be a ring or toroid shape, and that the cut coolant passage 641D may form more than one coolant passage wall 142 (see FIG. 1B).

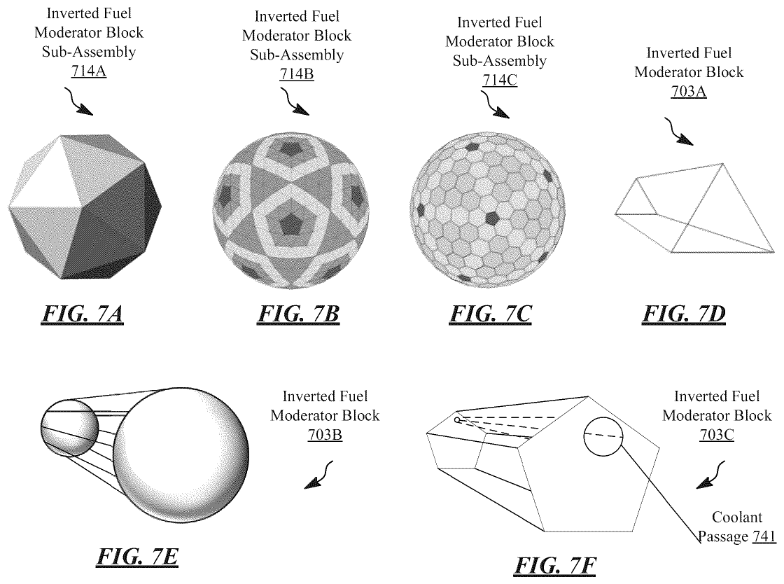

FIGS. 7A-C are examples of different block sub-assemblies 714A-C that inverted fuel moderator blocks may be assembled into. FIG. 7A is a view of an icosahedron inverted fuel moderator block sub-assembly 714A, made up of tapered triangular inverted fuel moderator blocks. FIG. 7B is a view of a polyhedron inverted fuel moderator block sub-assembly 714B, also made up of tapered triangular inverted fuel moderator blocks. FIG. 7C is a view of a truncated icosahedron inverted fuel moderator block sub-assembly 714C. This inverted fuel moderator block sub-assembly 714C is made up of tapered pentagonal inverted fuel moderator blocks of varying sizes. These inverted fuel moderator block sub-assemblies 714A-C may be solid, with inverted fuel moderator blocks extending to the center of the inverted fuel moderator block sub-assemblies 714A-C. Alternatively, the inverted fuel moderator block sub-assemblies 714A-C may have truncated tapered inverted fuel moderator blocks, and therefore the inverted fuel moderator block sub-assemblies 714A-C may be partially hollow, with a coolant reservoir enclosed within which expels heat via one or more exhaust coolant channels.

FIGS. 7D-F are examples of different inverted fuel moderator blocks 703A-C which may be used in assembling the inverted fuel moderator block sub-assemblies 714A-C of FIGS. 7A-C. FIG. 7D is a view of a tapered triangular inverted fuel moderator block 703A within a polyhedron of one or more triangular faces, such as the inverted fuel moderator block sub-assembles 714A-B of FIGS. 7A-B.

FIG. 7E is a view of a tapered circular inverted fuel moderator block 703B with a convex top cap and a concave bottom cap 155. This inverted fuel moderator block 703B further illustrates that the shape of the caps 155 may be arbitrary, in order to fit the needs of the nuclear reactor system 100. Further, it shows that the caps 155 may be concave or convex, in addition to flat or any other planar shape. FIG. 7F is a view of a tapered pentagonal inverted fuel moderator block 703C with a tapered coolant passage 741. This inverted fuel moderator block 703B would fit into a polyhedron of one or more pentagonal faces, such as the inverted fuel moderator block sub-assembly 714C of FIG. 7C. Further, the coolant passage 741 illustrates that the diameter of coolant passages 741 do not need to be uniform the entire length of the coolant passage. In particular, when implementing a polyhedron-shaped nuclear reactor core 101, it may be advantageous to have coolant passages 741 widen nearer the surface of the polyhedron-shaped nuclear reactor core 101 than at the center of the polyhedron-shaped nuclear reactor core 101, in order to maintain a ratio of coolant passage 741 surface area to inverted fuel moderator block volume at a given radius of the polyhedron.

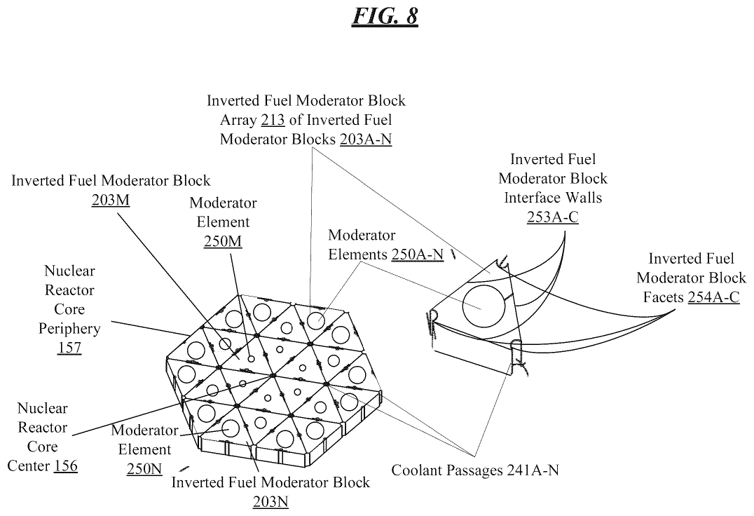

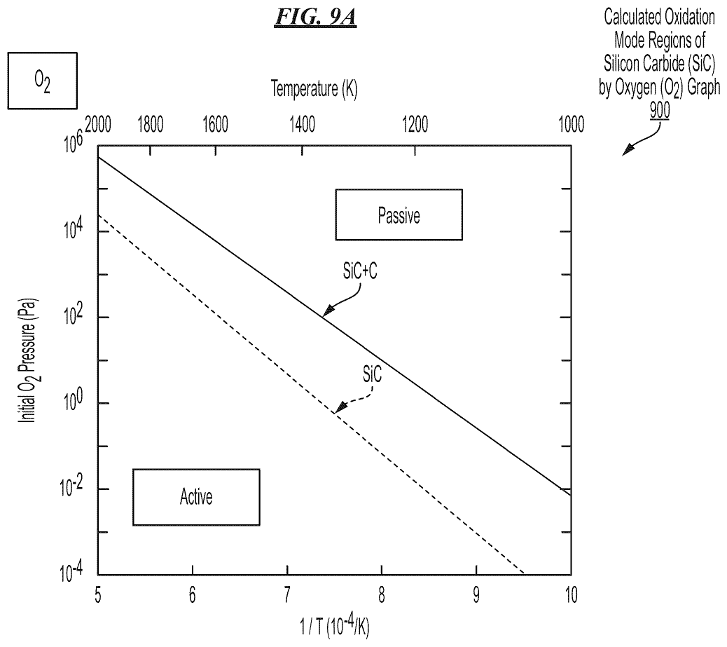

FIG. 8 is an isometric view of an inverted fuel moderator block array 213 formed of triangular inverted fuel moderator blocks 203A-N. The triangular fuel moderator blocks 203A-N include singular moderator elements 250A-N as well as inverted fuel moderator block facet 254A-C corners for flowing coolant, like FIG. 2. However, here the moderator openings are larger in inverted fuel moderator blocks 203A-N closer to the nuclear reactor core periphery 157 than inverted fuel moderator blocks closer to the nuclear reactor core center 156. As it is often desirable that the nuclear reactor core 101 be hotter at the nuclear reactor core center 156, the proportion of moderator element 250A-N to inverted fuel moderator block 203A-N is lower; whereas toward the nuclear reactor core periphery 157, in order to reduce excess neutron flux, the proportion of moderator element 250A-N to inverted fuel moderator block 203A-N is often higher.

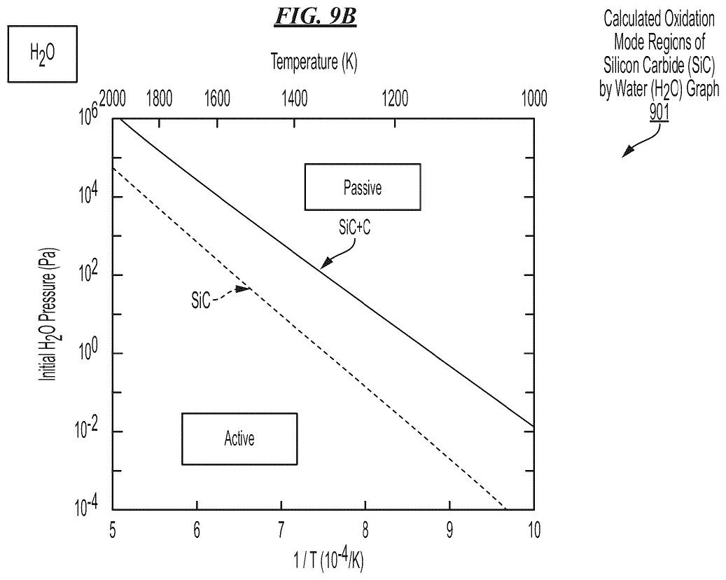

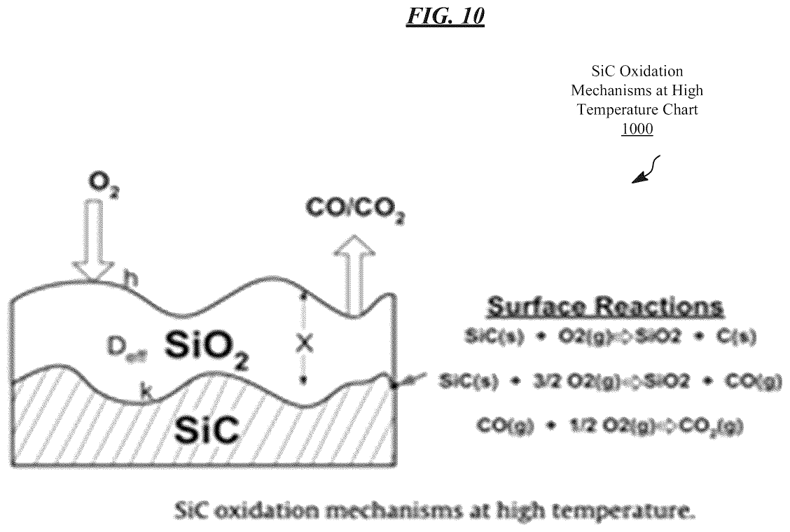

FIG. 9A is a graph 900 of the calculated oxidation mode regions of Silicon Carbide (SIC) by Oxygen (O₂). FIG. 9B is a graph 901 of the calculated oxidation mode regions of Silicon Carbide (SiC) by Water (H₂O). Both show improved coolant pressure (which translates into electrical energy) at given reactor temperature.

FIG. 10 is a chart 1000 of SiC oxidation mechanisms at high temperature.

Therefore, FIGS. 1A-10 depict an inverted fuel moderator block 103A including a high-temperature matrix 152, a plurality of fuel particles 151A-N embedded inside the high-temperature matrix 152, and at least one moderator opening 131A, such as a cavity, for disposition of at least one moderator element 150A therein.

In some examples, the inverted fuel moderator block 103B includes a base shape with an interlocking geometry pattern. The inverted fuel moderator block 103B may be shaped as a prism, a cylinder, a polyhedron, a truncated portion thereof, or a combination thereof. An inverted fuel moderator block 203A can include a plurality of block interface walls 253A-C, and the plurality of block interface walls 253A-C include planar, aspherical, spherical, or freeform surfaces.

The inverted fuel moderator block 103B can include at least one coolant passage 141A-B formed in the high-temperature matrix 152 to flow a coolant. The at least one coolant passage 141A-B can include a coolant passage wall 142 (see FIG. 1B), and the at least one coolant passage wall 142 includes a planar, aspherical, spherical, or freeform surface. The inverted fuel moderator block 103B can include a cap 155, wherein the cap 155 is a planar surface, a curved surface, or a combination thereof.

The plurality of fuel particles 151A-N can include coated fuel particles, and coated fuel particles can include tristructural-isotropic (TRISO) fuel particles, bistructural-isotropic (BISO) fuel particles, or TRIZO fuel particles. The high-temperature matrix 152 can include silicon carbide, zirconium carbide, titanium carbide, niobium carbide, tungsten, molybdenum, or a combination thereof.

FIGS. 1A-10 further depict a nuclear reactor core 101 including a plurality of moderator elements 150N-Z and an inverted fuel moderator block array 113 of one or more inverted fuel moderator blocks 103N-Z. The one or more inverted fuel moderator blocks 103N-Z include a high-temperature matrix 152, a plurality of fuel particles 151A-N embedded inside the high-temperature matrix 152, and at least one coolant passage 141A-B formed in the high-temperature matrix 152 to flow a coolant.

In some examples, a first moderator element 350A is layered between a first inverted fuel moderator block 303A and a second inverted fuel moderator block 303B.

FIGS. 1A-10 still further depict a nuclear reactor 107, including a nuclear reactor core 101 and a reactivity control system, wherein the reactivity control system includes one or more control drums 115, one or more control rods, or a combination thereof.

In some examples, a first volume of the inverted fuel moderator block array 113 is 1% to 20% of a total volume of the nuclear reactor core 101. A second volume of the plurality of moderator elements 150N-Z can be 70% to 99% of the total volume of the nuclear reactor core 101. The nuclear reactor core 101 can include a plurality of coolant passages 141A-B to flow a coolant, wherein a third volume of the plurality of coolant passages 141A-B is 0% to 10% of the total volume of the nuclear reactor core 101. One or more of the moderator elements 350B can be a truncated polyhedron shape that includes one or more moderator interface walls 390 and one or more moderator facets 3910-Z, and the one or more moderator facets 3910-Z border a respective inverted fuel moderator block 303O-Z. One or more inverted fuel moderator blocks 203A-N can be a truncated polyhedron shape that includes one or more inverted fuel moderator block interface walls 253A-C and one or more inverted fuel moderator block facets 254A-C. The at least one coolant passage 241A-N is formed of the one more inverted fuel moderator block facets 254A-C. The one or more inverted fuel moderator blocks 203A-N can include at least one moderator opening 231A-N, such as a cavity, for disposition of at least one moderator element 250A-N therein. The one or more inverted fuel moderator blocks 503 can include one or more cut coolant passages 641A-D to flow the coolant.

The nuclear reactor core 101 can further include a plurality of inverted fuel moderator blocks 703A-C that include a polyhedron or a truncated polyhedron shape. The polyhedron or the truncated polyhedron shape of the inverted fuel moderator blocks 703A-C form a polygonal or truncated polyhedron sub-assembly 714A-C. The one or more inverted fuel moderator blocks 703B can be a convex polyhedron shape.

FIGS. 1-10 yet further depict a nuclear reactor core 101, including a core center 156 and a core periphery 157. A core center inverted fuel moderator block 203M including at least one core moderator element 250M is closer to the core center 156 than the core periphery 157. A core periphery inverted fuel moderator block 203N including at least one periphery moderator element 250N is closer to the core periphery 157 than the core center 156. A core volumetric proportion of the core center inverted fuel moderator block 203M to the at least one core moderator element 250M differs from a periphery volumetric proportion of the core periphery inverted fuel moderator block 203N to the at least one periphery moderator element 250N.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. An inverted fuel moderator block, comprising:
a high-temperature matrix;
a plurality of fuel particles embedded inside the high-temperature matrix; and
at least one moderator opening for disposition of at least one moderator element therein.

2. The inverted fuel moderator block of claim 1, wherein the inverted fuel moderator block includes a base shape with an interlocking geometry pattern.

3. The inverted fuel moderator block of claim 1, wherein the inverted fuel moderator block is shaped as a prism, a cylinder, a polyhedron, a truncated portion thereof, or a combination thereof.

4. The inverted fuel moderator block of claim 1, wherein:
the inverted fuel moderator block includes a plurality of block interface walls; and
the plurality of block interface walls include planar, aspherical, spherical, or freeform surfaces.

5. The inverted fuel moderator block of claim 1, further comprising at least one coolant passage formed in the high-temperature matrix to flow a coolant.

6. The inverted fuel moderator block of claim 5, wherein:
the at least one coolant passage includes a coolant passage wall; and
the at least one coolant passage wall includes a planar, aspherical, spherical, or freeform surface.

7. The inverted fuel moderator block of claim 1, wherein the inverted fuel moderator block includes a cap, wherein the cap is a planar surface, a curved surface, or a combination thereof.

8. The inverted fuel moderator block of claim 1, wherein the plurality of fuel particles include coated fuel particles.

9. The inverted fuel moderator block of claim 8, wherein:
the coated fuel particles include tristructural-isotropic (TRISO) fuel particles, bistructural-isotropic (BISO) fuel particles, or TRIZO fuel particles; and
high-temperature matrix includes silicon carbide, zirconium carbide, titanium carbide, niobium carbide, tungsten, molybdenum, or a combination thereof.

10. A nuclear reactor core, comprising:
a plurality of moderator elements; and
an inverted fuel moderator block array of one or more inverted fuel moderator blocks, wherein the one or more inverted fuel moderator blocks include:
a high-temperature matrix;
a plurality of fuel particles embedded inside the high-temperature matrix; and
at least one coolant passage formed in the high-temperature matrix to flow a coolant.

11. The nuclear reactor core of claim 10, wherein:
a first moderator element is layered between a first inverted fuel moderator block and a second inverted fuel moderator block.

12. A nuclear reactor, comprising:
the nuclear reactor core of claim 10; and
a reactivity control system, wherein the reactivity control system includes:
(a) one or more control drums;
(b) one or more control rods; or
(c) a combination thereof.

13. The nuclear reactor core of claim 10, wherein a first volume of the inverted fuel moderator block array is 1% to 20% of a total volume of the nuclear reactor core.

14. The nuclear reactor core of claim 13, wherein a second volume of the plurality of moderator elements is 70% to 99% of the total volume.

15. The nuclear reactor core of claim 14, further comprising a plurality of coolant passages to flow a coolant, wherein a third volume of the plurality of coolant passages is 0% to 10% of the total volume.

16. The nuclear reactor core of claim 10, wherein:
one or more of the moderator elements are a truncated polyhedron shape that includes one or more moderator interface walls and one or more moderator facets; and
the one or more moderator facets border a respective inverted fuel moderator block.

17. The nuclear reactor core of claim 10, wherein:
one or more inverted fuel moderator blocks are a truncated polyhedron shape that includes one or more inverted fuel moderator block interface walls and one or more inverted fuel moderator block facets;
the at least one coolant passage is formed of the one more inverted fuel moderator block facets; and
the one or more inverted fuel moderator blocks include at least one moderator opening for disposition of at least one moderator element therein.

18. The nuclear reactor core of claim 17, wherein the one or more inverted fuel moderator blocks include one or more cut coolant passages to flow the coolant.

19. The nuclear reactor core of claim 10, further comprising a plurality of inverted fuel moderator blocks that include a polyhedron or a truncated polyhedron shape, wherein:
the polyhedron or the truncated polyhedron shape of the inverted fuel moderator blocks form a polygonal or truncated polyhedron sub-assembly.

20. The nuclear reactor core of claim 10, wherein the one or more inverted fuel moderator blocks are a convex polyhedron shape.

21. (canceled)
